(19) United States
(12) Patent Application Publication
(10) Pub. No.: US 2019/0111904 A1
(43) Pub. Date: Apr. 18, 2019

(54) BRAKE SYSTEM, RAIL VEHICLE HAVING A BRAKE SYSTEM, AND METHOD FOR OPERATING A BRAKE SYSTEM

(71) Applicant: SIEMENS MOBILITY GMBH, MUENCHEN (DE)

(72) Inventors: JENS PETER LICHTERFELD, ERLANGEN (DE); HARALD WERNERT, GAWEINSTAL (AT)

(21) Appl. No.: 16/090,323

(22) PCT Filed: Mar. 20, 2017
(86) PCT No.: PCT/EP2017/056482

§ 371 Date: Oct. 1, 2018

(30) Foreign Application Priority Data
Mar. 29, 2016 (DE) 10 2016 205 125.3

(51) Int. Cl. B60T 13/36; B60T 17/22; B60T 13/68; B60T 8/17

(52) U.S. Cl. CPC B60T 13/365; B60T 8/1705; B60T 13/683; B60T 17/228

(57) ABSTRACT

A brake system has a first emergency brake control valve, a first emergency brake flow path, which is operatively connected to at least one first compressed-air brake cylinder, an emergency line, and a first switch-over valve, the pneumatic control connection of which is connected to the emergency line. The emergency line is kept at zero pressure during a service operation of the brake system, and pressurized during an emergency operation such that during the service operation, the first switch-over valve is kept in a first position, and during an emergency operation, the first switch-over valve means is kept in a second position. The first position of the first switch-over valve opens the first emergency brake flow path and blocks a first emergency flow path to compressed air controlled by an emergency control valve. The second position blocks the first emergency brake flow path and clears the first emergency flow path.

The invention relates to a brake system with a first emergency brake control valve means, a first emergency brake flow path which is operatively connected to at least one first compressed-air brake cylinder for compressed air applied by the first emergency brake control valve means, an emergency line and a first switch-over valve means, the pneumatic control connection of which is connected to the emergency line, wherein the emergency line is kept at zero pressure during a service operating mode of the brake system and during an emergency operating mode of the brake system a pressure is applied to the emergency line such that, in service operating mode, the first switch-over valve means is kept in a first position and in emergency operating mode it is kept in a second position.

The invention also relates to a rail vehicle having a brake system of this type.

Moreover the invention relates to a method for operating a brake system, which is provided with a first emergency brake control valve means, a first emergency brake flow path which is operatively connected to at least one first compressed-air brake cylinder for compressed air applied by the first emergency brake control valve means, an emergency line and a first switch-over valve means, the pneumatic control connection of which is connected to the emergency line (NL), wherein the emergency line is kept at zero pressure during a service operating mode of the brake system and during an emergency operating mode of the brake system a pressure is applied to the emergency line such that, in service operating mode, the first switch-over valve means is kept in a first position and in emergency operating mode it is kept in a second position.

A generic brake system, a rail vehicle with a generic brake system and also a generic method are known for example from publication EP 2 165 902 B1, wherein the first emergency brake control valve means is constructed in the form of electro-pneumatic control valve means and wherein the first switch-over valve means is embodied in the form of compressed-air brake actuation valve means, which is constructed from one or more pneumatically-actuated valves. The electro-pneumatic control valve means in this case is connected between a brake supply reservoir (brake pressure reservoir) and a compressed-air brake cylinder and has the effect of connecting the compressed-air brake cylinder to the brake supply reservoir when it is not supplied with energy and that the compressed-air brake cylinder is vented when it is supplied with energy. The compressed-air brake actuation valve means serves to isolate the brake supply reservoir (brake pressure reservoir) from the electro-pneumatic control valve means and to vent the compressed-air brake cylinder when pressure is available in the emergency line, and to connect the brake supply reservoir (brake pressure reservoir) to the electro-pneumatic control valve means when no pressure is available in the emergency line.

The underlying object of the invention is to improve the braking behavior of a generic brake system, in particular for the purpose of being able to better rescue a rail vehicle equipped with the brake system in an emergency situation autonomously or using a further rail vehicle—i.e. of being able to move it to a safe section of track.

This object is achieved by a brake system with the features of claim 1, in which the first switch-over valve is embodied such that, in its first position, the first emergency brake flow path is cleared and a first emergency flow path is blocked for compressed air applied by an emergency control valve means and that, in its second position, the first emergency brake flow path is blocked and the emergency flow path is cleared.

Thus, in the inventive brake system, operating actions are not required in all cars of a rail vehicle equipped with said system in order to rescue the rail vehicle and also no additional electrical connections have to be established.

In this case it is seen as advantageous for the brake system to have a second emergency control valve means and a second switch-over valve means, the pneumatic control connection of which is connected to the emergency line, so that the second switch-over valve means is kept in a first position during service operating mode and in a second position during emergency operating mode. Here the second emergency control valve means is embodied such that, in its first position, a second emergency brake flow path having an operative connection to at least one second compressed-air brake cylinder is cleared for compressed air applied by the second emergency control valve means and a second emergency flow path is blocked for compressed air applied by the emergency control valve means and that, in its second position, the second emergency flow path is blocked and the second emergency flow path is cleared.

On the other hand it is seen as advantageous for the brake system to have a parking brake actuation valve means and a third switch-over valve means, the pneumatic control connection of which is connected to the emergency line, so that, during service operating mode, it is kept in a first position and during emergency operating mode it is kept in a second position. Here the third switch-over valve means is embodied such that, in its first position, a parking brake actuation flow path having an operative connection to at least one parking brake actuation cylinder is cleared for compressed air applied by the parking brake actuation cylinder and an emergency actuation flow path is blocked for compressed air applied by the emergency control valve means, and that, in its second position, the parking brake actuation flow path is blocked and the emergency actuation flow path is cleared.

It is advantageous for the first switch-over valve means to have pneumatic connections, of which a first connection is connected to a pneumatic connection of the first emergency brake control valve means and a second connection has an operative connection to the at least one first compressed-air brake cylinder, and for the emergency control valve means to have a pneumatic control connection connected to the emergency line, a pneumatic supply connection connected to the brake supply reservoir and a pneumatic connection connected to the first switch-over valve means.

In a similar way the second switch-over valve means preferably has pneumatic connections, of which a first connection is connected to a pneumatic connection of the second emergency brake control valve means, a second connection has an operative connection to the at least one second compressed-air brake cylinder and a third connection is connected to the connection of the emergency control valve means.

Furthermore there is preferably provision for the third switch-over valve means to have pneumatic connections, of which a first connection is connected to a pneumatic connection of the parking brake actuation valve means, a second connection has an operative connection to the at least one parking brake actuation cylinder and a third connection is connected to the connection of the emergency control valve means.

The use of a first pressure converter with a pneumatic supply connection is advantageous, which is connected to the brake supply reservoir, with a connection which is connected to the at least one first compressed-air brake cylinder, and with a first pneumatic control connection, which is connected to the second pneumatic connection of the first switch-over valve means.

The use of a second pressure converter with a pneumatic supply connection is also advantageous, which is connected to the brake supply reservoir, with a connection which is connected to the at least one first compressed-air brake cylinder, and with a first pneumatic control connection which is connected to the second pneumatic connection of the first switch-over valve means.

The use of a first switch-over valve means is furthermore advantageous, with a first pneumatic input, a second pneumatic input and a pneumatic output, wherein the first input is connected to the connection of the first pressure converter and the second input is connected to the connection of the second pressure converter.

The use of a second switch-over valve means with a first pneumatic input, a second pneumatic input and a pneumatic output is further advantageous, wherein the first input is connected to the output of the first switch-over valve means, the second input is connected to the second pneumatic connection of the third switch-over valve means and the output is connected to the at least one parking brake actuation cylinder.

Preferably the braking system has an emergency pressure control module for controlling the pressure in the emergency line and an activation valve means for activating the emergency pressure control module.

The object underlying the invention is also achieved by a method with the features of claim 13, in which the first switch-over valve means, in its first position, clears the first emergency brake flow path and blocks a first emergency flow path for compressed air applied by an emergency control valve means and, in its second position, blocks the first emergency brake flow path and clears the first emergency flow path.

On the one hand it is seen as advantageous for the brake system to be provided with a second emergency brake control valve means and a second switch-over valve means, of which the pneumatic control connection is connected to the emergency line, so that in service operating mode it is kept in a first position and in emergency operating mode it is kept in a second position. In its first position the second switch-over valve means clears a second emergency flow path having an operative connection to at least one compressed-air brake cylinder for compressed air applied by the second emergency brake control valve means and blocks a second emergency flow path for compressed air applied by the emergency control valve means. In its second position the second switch-over valve means blocks the second emergency brake flow path and clears the second emergency flow path.

On the other hand it is seen as advantageous for the brake system to be provided with a parking brake actuation valve means and a third switch-over valve means, of which the control connection is connected to the emergency brake line, so that during service operating mode it is kept in a first position and during emergency operating mode it is kept in a second position. In its first position the third switch-over valve means clears a parking brake actuation flow path having an operative connection to a parking brake actuation cylinder for compressed air applied by the parking brake actuation valve means and blocks an emergency flow path for compressed air applied by the emergency control valve means. In its second position the third switch-over valve means blocks the parking brake actuation flow path and clears the emergency flow path.

The invention is explained in greater detail below on the basis of figures. In the figures:

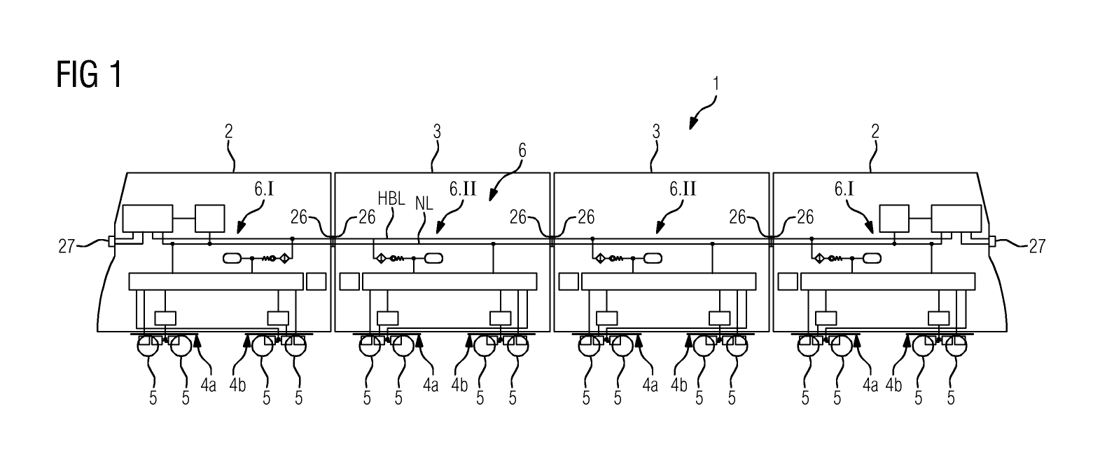

FIG. 1 shows a schematic diagram of a rail vehicle with two drive cars and two non-driven cars and with an inventive brake system, wherein each of the drive cars and each non-driven car of the rail vehicle is provided with a brake arrangement of the brake system,

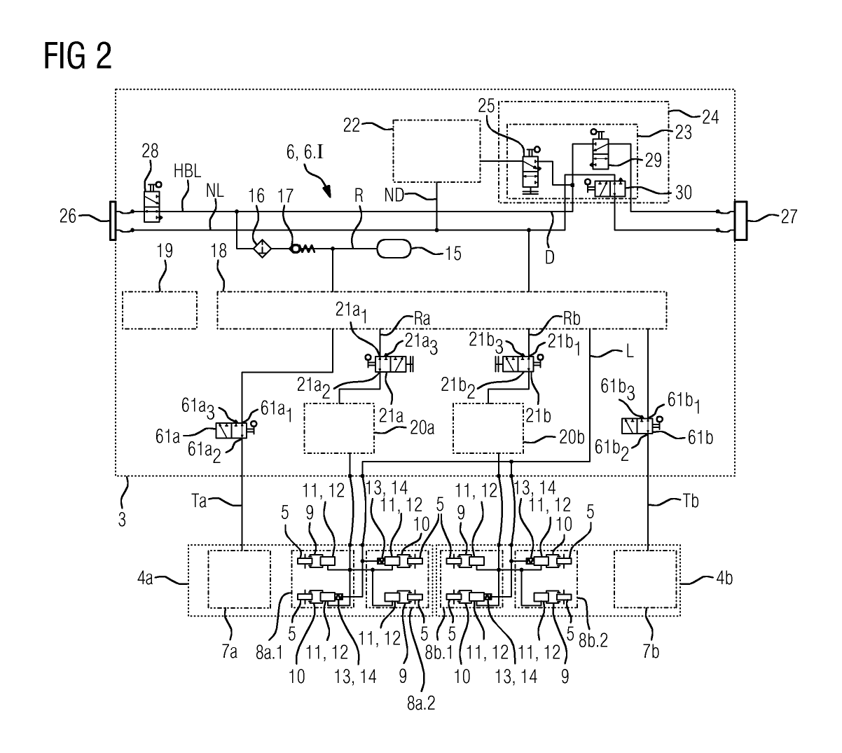

FIG. 2 shows a brake arrangement of a drive car,

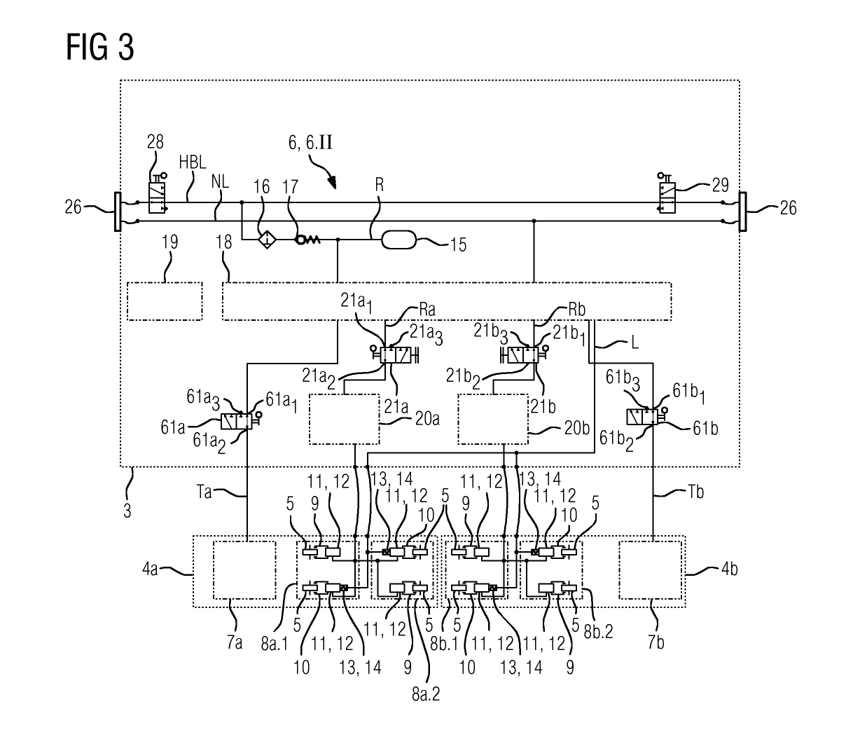

FIG. 3 shows a brake arrangement of a non-driven car,

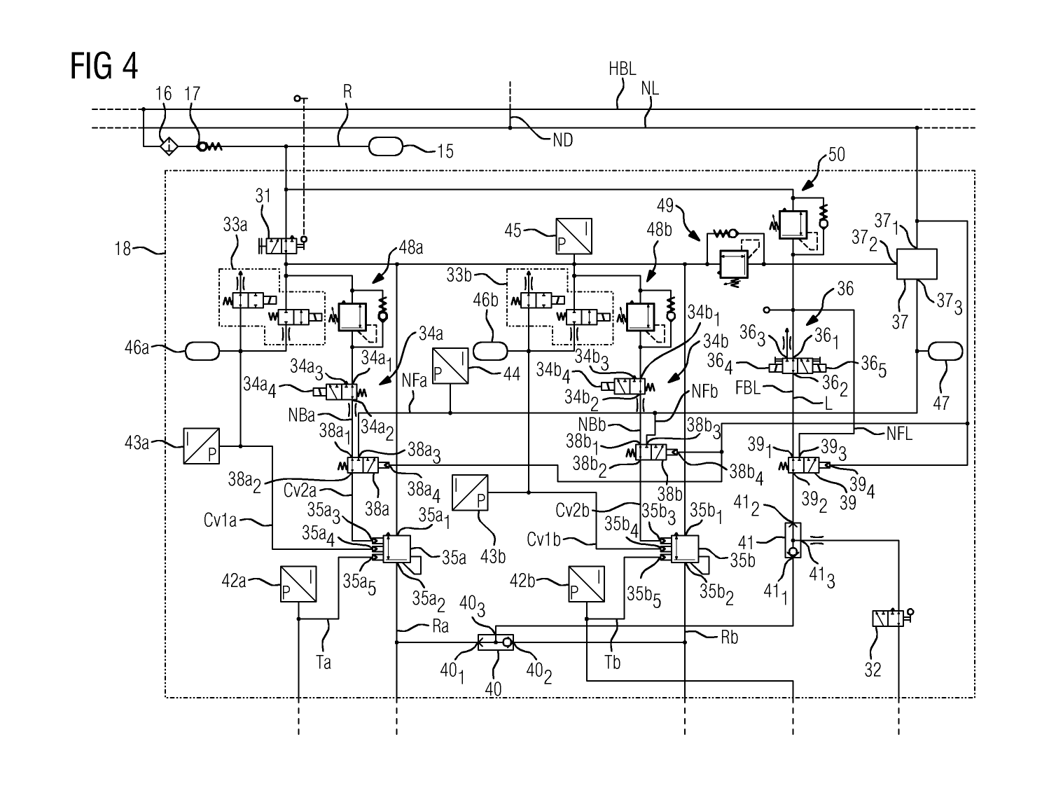

FIG. 4 shows a section of one of the brake arrangements, which is embodied the same for all brake arrangements, with a brake panel,

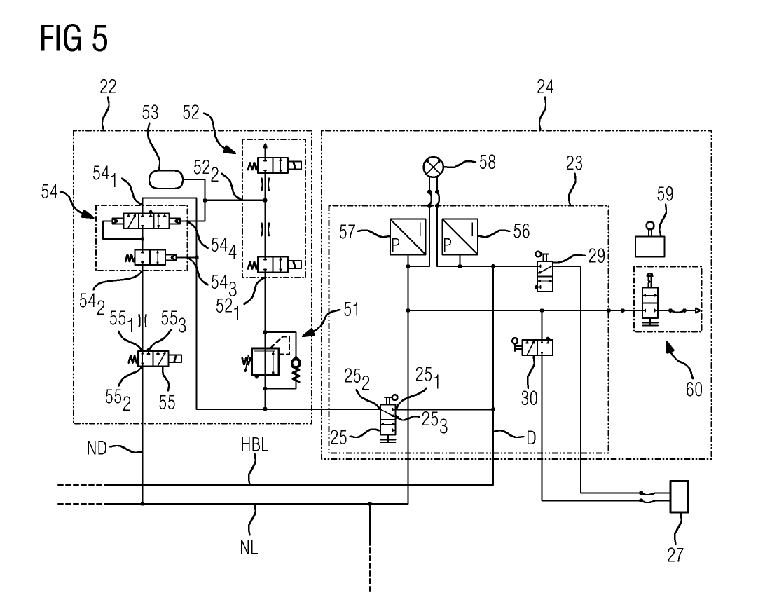

FIG. 5 shows a further section from a brake arrangement of one of the drive cars with emergency brake equipment and

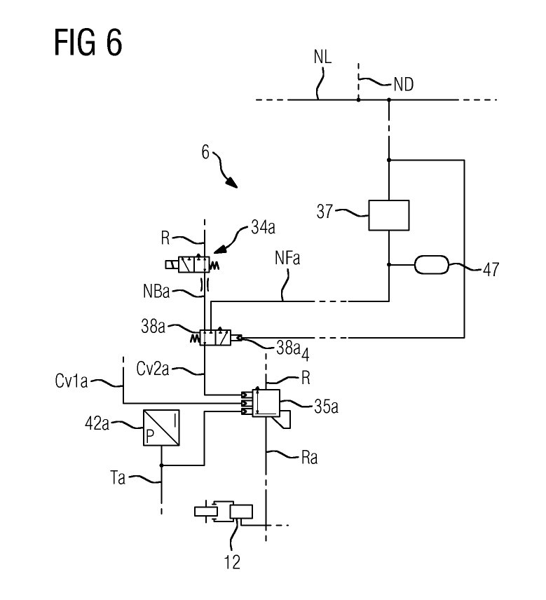

FIG. 6 shows an enlarged section from FIG. 4.

The inventive rail vehicle 1 shown in FIG. 1 has two drive cars 2 and two non-driven cars 3 for example. The drive cars 2 and the non-driven cars 3 each have two bogies 4a and 4b, wherein each of the bogies 4a and 4b is provided with two wheel sets 5, to which brake actuators not shown in the FIG. 1 are assigned. The inventive rail vehicle 1 is provided with a brake system 6. A main air reservoir line HBL and an emergency line NL—also called a rescue brake pipe—belong to the brake system 6. The main air reservoir line HBL and the emergency line NL run through all cars 2 of the rail vehicle. Each drive car 2 of the rail vehicle is provided with a brake arrangement 6.I of the brake system 6. And each non-driven car 3 of the rail vehicle is provided with a brake arrangement 6.II of the brake system 6.

In accordance with FIGS. 2 and 3, each of the brake arrangements 6.I and 6.II has an air suspension unit 7a or 7b, on the bogie side for each bogie 4a or 4b, and has a brake caliper device 8a.1, 8a.2, 8b.1, 8b.2 with a brake caliper unit 9 and 10 for each wheel set 5. The brake caliper units 9 and 10 comprise the brake actuators, wherein the brake caliper units 9 each have only one compressed-air brake actuator 11 with compressed-air brake cylinder 12 and wherein the brake caliper units 10 each have a combination of a compressed-air brake actuator 11 with compressed-air brake cylinder 12 and a parking brake actuator 13 with parking brake actuation cylinder 14.

On the car side each of the brake arrangements 6.I and 6.II has a brake supply reservoir 15, which is connected in the way shown via a connection formed from pneumatic line sections, in the course of which a filter 16 and a non-return valve 17 are arranged, to the main air reservoir line HBL and which provides a brake supply pressure R.

Furthermore each of the brake arrangements 6.I and 6.II on the car side has a brake device unit 18 in the form of a brake panel, a drive and brake unit 19 in the form of an electronic brake control device arrangement, wheel-slide protection units 20a, 20b and shut-off devices 21a, 21b and also 61a, 61b.

The drive and brake unit 19 is used, inter alia, for activating electrically-activatable components of the brake device unit 18, wherein, for the sake of clarity, the corresponding electrical connections are not shown in the figures.

The brake device unit 18 of each of the brake arrangements 6.I and 6.II is connected in the way shown via pneumatic line sections to the brake supply reservoir 15, so that the brake device unit 18 is supplied with the compressed air of the brake supply reservoir 15—i.e. with the brake supply pressure R.

The brake device unit 18 of one of the brake arrangements 6.I and 6.I in each case is moreover connected in the way shown via a pneumatic line section to the emergency line NL.

The brake device unit 18 of one of the brake arrangements 6.I and 6.II in each case is further connected on the one hand via a first of the shut-off units 21a and a first of the wheel-slide protection units 20a as well as assigned pneumatic line sections, which for the sake of clarity are not shown in any greater detail, to the compressed-air brake cylinders 12 of the compressed-air brake actuators 11 of a first bogie 4a of the bogies of the respective cars.

On the other hand the brake device unit 18 of one of the respective brake arrangements is connected via the second shut-off unit 21b and the second wheel-slide protection unit 20b as well as assigned pneumatic line sections to the compressed-air brake cylinders 12 of the compressed-air brake actuators 11 of the second bogie of the respective car.

The brake pressures Ra or Rb for the compressed-air brake actuators 11 are thus controlled bogie by bogie. Such a bogie-by-bogie method of control is preferably provided when the rail vehicle 1 is a high-speed rail vehicle.

As an alternative thereto, brake pressures for the compressed-air brake actuators can be controlled car by car, preferably when the rail vehicle 1 is a commuter vehicle or regional vehicle.

Moreover the brake device unit 18 of one of the respective brake arrangements is connected via corresponding pneumatic line sections to the parking brake actuating cylinders 14 of the parking brake actuators 15 of the two bogies 4a and 4b of the respective car.

A parking brake actuation pressure L for the parking brake actuating cylinders 14 is thus controlled car by car.

Each of the bogies 4a or 4b is provided with one of the air suspension units 7a or 7b, which are connected in the way shown via assigned pneumatic line sections to the brake device unit 18 of the respective car and output a load pressure Ta or Tb to the brake device unit 18.

In accordance with FIG. 2 the brake device units 18 of the brake arrangements 6.I of the drive cars 2 each additionally have emergency brake equipment. This emergency brake equipment comprises an emergency pressure control module 22 for controlling the pressure PD in the emergency line NL and—as a component of a cabin module 23 of a cabin device 24—an activation means 25 for activating the emergency pressure control module 22.

The activation means 25 has three connections 25₁, 25₂ and 25₃, of which a first connection 25₁ is connected to the main air reservoir line HBL and a second connection 25₂ is connected to the emergency pressure control module 22 and the third connection 25₃ is provided with venting of the air into the open air.

In accordance with FIGS. 1 to 3, coupling devices 26 serve to connect the individual car sections of the main air reservoir line HBL and of the emergency line NL of the rail vehicle.

Via one of the coupling devices 27 shown in FIGS. 1 and 2 for example, on the one hand the main air reservoir line HBL of the rail vehicle 1 is able to be connected to a main reservoir supply line of a further rail vehicle not shown here and on the other hand the emergency line NL of the rail vehicle 1 is able to be connected to the emergency line NL of the further rail vehicle. The inventive brake system offers the advantage that, when the rail vehicle 1 is being towed by a further rail vehicle, there do not have to be any electrical connections between the rail vehicle 1 and the further rail vehicle.

In accordance with FIGS. 2 and 3 the ends of the section of the main air reservoir line HBL extending through a car are provided with a shut-off device 28 or 29, which is situated upstream of the coupling device 26 or 27. In this case the shut-off device 29 of the respective drive car 2 is part of the cabin module 23 of the cabin device 24. Moreover the cabin module 23 of a respective drive car 2 has a further shut-off device 30, which is arranged in the course of the emergency line NL.

In service operating mode of the rail vehicle 1 the shut-off devices 29, 30 are in the first positions shown in FIGS. 2 and 3, so that on the one hand the main air reservoir line HBL is closed at its ends by the shut-off devices 29 of the two drive cars 2 and on the other hand the emergency line NL is opened towards the coupling devices 27 at its ends by the shut-off devices 30 of the two drive cars 2—and is thus vented into the open air.

If the rail vehicle is to be rescued under its own power in an emergency, then initially the shut-off devices 30 of the two drive cars 2 must be moved into their second position, in order to close off the emergency line NL at its ends. Subsequently the activation means 25 of one of the drive cars 2 (preferably the drive car pointing in the direction of travel) should be moved from its blocked position shown in the figures into its activation position. In the blocked position the connections 25₂ and 25₃ are connected and thus the emergency pressure control module 22 vents into the open air. In the activation position the activation means forwards the pressure D of the main air reservoir line HBL in the direction of the emergency pressure control module 22, since its connection 25₁ is connected to its connection 25₂.

In accordance with FIG. 4, each one of the brake device units 18 comprises two shut-off devices 31 and 32, two directly-acting brake pressure regulators 33a and 33b, two directly-acting emergency brake control valve means 34a and 3b, two relay valve means 35a and 35b acting as pressure converters, a parking brake actuation valve means 36, an emergency control valve means 37 in the form of an indirectly-acting brake pressure control, three switch-over valve means 38a, 38b and 39, two changeover valve means 40 and 41 and the pressure sensors 42a or 42b assigned to the air suspension units 7a or 7b. In addition each of the brake device units 18 comprises further elements, not all of which are shown in FIG. 3 for reasons of clarity. These further elements include further pressure sensors 43a, 43b, 44, 45, compressed air reservoirs 46a, 46b, 47, pressure reduction valve means 48a, 48b, 49, 50 and also pressure switches.

In accordance with FIG. 5 the emergency pressure control module 22 of the emergency brake equipment of the drive car 2 has a pressure reduction valve means 51, a pressure regulator 52 with air inlet valve and air outlet valve, a compressed air reservoir 53, a relay valve means acting as a pressure converter and also an electrically-actuatable emergency brake valve means 55.

The cabin module 23, in addition to the activation means 25 and the shut-off devices 29 and 30, has two pressure sensors 56 and 57.

As well as the cabin module 23, a double manometer 58, a speed and brake regulator 59 and an emergency brake button 60 belong to the cabin device 24.

The brake device unit 18 shown in FIG. 4 is described in greater detail below.

In the brake device unit 18 operative connections from a first of the switch-over valve means 38a to the compressed-air brake cylinders 12 of the first bogie 4a are formed by means of a first of the pressure converters 35a. Operative connections from the second switch-over valve means 38a to the compressed-air brake cylinders 12 of the second bogie 4b are formed by means of the second pressure converter 35b.

In addition operative connections from a first of the switch-over valve means 38a to the compressed-air brake cylinders 12 of the second bogie 4b are formed by means of the first pressure converter 35a and first of the changeover valve means 40 and by means of the second pressure converter 35b and the first changeover valve means 40 operative connections are formed from a second of the switch-over valve means 38b to the compressed-air brake cylinders 12 of the first bogie 4a.

Moreover operative connections are formed from the third switch-over valve means 39 to the parking brake actuation cylinders 14 of the two bogies 4a and 4b of the respective car by means of the second changeover valve means 41.

Furthermore operative connections are formed from the first switch-over valve means 38a and the second switch-over valve means 38b to the parking brake actuation cylinders 14 of the two bogies 4a and 4b of the respective car are formed by means of the two pressure converters 35a, 35b and the two changeover valve means 40, 41.

To form the said operative connections, the first pressure converter 35a has a pneumatic supply connection 35a₁ connected to the brake supply reservoir 15, a pneumatic supply connection 35a₂ and three pneumatic supply connections 35a₃, 35a₄ and 35a₅. The pressure converter 35a outputs the brake pressure Ra at the pneumatic connection 35a₂. Here the pneumatic connection 35a₂ is connected via pneumatic line sections to the first connection 21a₁ of the shut-off unit 21a, which in the open position of the shut-off unit 21a shown in FIGS. 2 and 3, is connected to the shut-off connection 21a₂ and from there, in accordance with FIGS. 2 and 3, via the wheel-slide protection unit 20a, to the compressed-air brake cylinders 12 of the first bogie 4a of the respective car.

Accordingly the second pressure converter 35b has a pneumatic supply connection 35b₁ connected to the brake supply reservoir 15, a pneumatic supply connection 35b₂ and three pneumatic supply connections 35b₃, 35b₄ and 35b₅. The pressure converter 35b outputs the brake pressure Rb at the pneumatic connection 35b₂. Here the pneumatic connection 35b₂ is connected via pneumatic line sections to the first connection 21b₁ of the shut-off unit 21b, which in the open position of the shut-off unit 21b shown in FIGS. 2 and 3, is connected to the shut-off connection 21b₂ and from there, in accordance with FIGS. 2 and 3, via the wheel-slide protection unit 20a, to the compressed-air brake cylinders 12 of the bogie 4b of the respective car.

The first changeover valve means 40 has a first pneumatic input 40₁, a second pneumatic input 40₂ and a pneumatic output 40₃, wherein the first input 40₁ is connected to the second connection 35a₂ of the first pressure converter 35a and the second input 40₂ is connected to the connection 35b₂ of the second pressure converter 35b.

The second changeover valve means 41 has a first pneumatic input 41₁, a second pneumatic input 41₂ and a pneumatic output 41₃, wherein the first input 41₁ is connected to the output 40₃ of the first changeover valve means 40, the second input 41₂ to the second pneumatic connection 39₂ of the third switch-over valve means 39 and the output 41₃ to the parking brake actuation cylinders 14 of the two bogies 4a, 4b.

A first of the emergency brake valve means 34a has a pneumatic supply connection 34a₁, a pneumatic connection 34a₂ and a venting connection 34a₃. Moreover the first emergency brake valve means 34a has an electrical control connection 34a₄ activated by the brake control unit 19.

The second emergency brake valve means 34b has a pneumatic supply connection 34b₁, a pneumatic connection 34b₂ and a venting connection 34b₃. Moreover the second emergency brake valve means 34b has an electrical control connection 34b₄ activated by the brake control unit 19.

Furthermore the parking brake actuation valve means 36 has a pneumatic supply connection 36₁, a pneumatic connection 36₂ and a venting connection 36₃. Moreover the parking brake actuation valve means 36 has two electrically-activated control connections 36₄ and 36₅.

A first emergency brake flow path NBa is embodied by pneumatic line sections for compressed air applied by the first emergency brake control valve means 34a (see also FIG. 6). The emergency brake flow path NBa extends from connection 34a₂ of the emergency brake control valve means 34a to the first of the control connections 35a₂ of the first pressure converter 35a.

This first emergency brake flow path NBa is thus, by means of the first pressure converter 35a, in an operative connection with the compressed-air brake cylinders 12 of the first bogie 4a of the respective car.

Moreover this first emergency brake flow path NBa, by means of the first pressure converter 35a and the first switchover valve means 40, is also in an operative connection with the compressed-air brake cylinders 12 of the second bogie 4b of the respective car.

Furthermore a first emergency flow path NFa is formed by pneumatic line sections for compressed air applied by the emergency control valve means 37 (see also FIG. 6).

The emergency control valve means 37 has a pneumatic control connection 37₁ connected to the emergency line NL, a pneumatic supply connection 37₂ connected via one of the pressure reduction valve means 49 to the brake supply reservoir 15 and a connection 37₃, wherein the emergency flow path NFa extends from the connection 37₃ of the emergency control valve means 37 to the first control connection 35a₂ of the first pressure converter 35a.

The first emergency flow path NFa likewise has an operative connection, by means of the first pressure converter 35a, to the compressed-air brake cylinders 12 of the first bogie 4a of the respective car or has an operative connection, by means of the first pressure converter 35a and the first changeover valve means 40, to the compressed-air brake cylinders 12 of the second bogie 4b.

A first of the switch-over valve means 38a is arranged in the course of the first emergency brake flow path NBa and the first emergency flow path NFa, which has pneumatic connections 38a₁, 34a₂, 34a₃. A first of the connections 38a₁ is connected to the pneumatic connection 34a₂ of the first emergency brake control valve means 34a. A second of the connections 38a₂ is connected to the control connection 35a₃ of the pressure converter 35a and thus has an operative connection to the compressed-air brake cylinders 12 of the first bogie 4a of a respective car. Moreover the first switch-over valve means 38a has a pneumatic control connection 38a₄ connected to the emergency line NL.

In a service operating mode of the brake system 6, the emergency line NL is kept at zero pressure (PD=0), so that the first switch-over valve means 38a is kept in a first position (as shown in FIG. 4).

In an emergency operating mode of the brake system 6, a pressure PD≠0 is applied in the emergency line (NL), so that the first switch-over valve means 38a is kept in a second position.

The first switch-over valve means 38a is embodied such that, in its first position, the first emergency brake flow path NBa is cleared and also the first emergency flow path NFa is blocked and that, in its second position, the first emergency brake flow path NBa is blocked and also the first emergency flow path NFa is cleared.

In the same way, in the brake device unit 18, a second emergency brake flow path NBb is embodied by pneumatic line sections for compressed air applied by the second emergency brake valve means 34b, which extends from connection 34b₂ of the second emergency brake valve means 34b to a first of the control connections 35b₃ of the second pressure converter 35b.

This second emergency brake flow path NBb thus, by means of the second pressure converter 35b, has an operative connection to the compressed-air brake cylinders 12 of the second bogie 4b of the respective car.

This second emergency brake flow path NBb also has an operative connection, by means of the first pressure converter 35a and the first changeover valve means 40, to the compressed-air brake cylinders 12 of the first bogie 4a of the respective car.

Furthermore a second emergency flow path NFa is formed by pneumatic line sections for compressed air applied by an emergency control valve means 37, which extends from the connection 37₃ of the emergency control valve means 37 to the connection 35b₃ of the second pressure converter 35b.

This second emergency brake flow path NBb also has an operative connection, by means of the second pressure converter 35b, to the compressed-air brake cylinders 12 of the second bogie 4b of the respective car or has an operative connection, by means of the second pressure converter 35b and the first changeover valve means 40, to the compressed-air brake cylinders 12 of the first bogie 4a.

The second switch-over valve means 38b is arranged in the course of the second emergency brake flow path NBb and the second emergency flow path NFb, which has pneumatic connections 38b₁, 34b₂, 34b₃. A first of the connections 38b₁ is connected to the pneumatic connection 34b₂ of the second emergency brake control valve means 34b. A second of the connections 38b₂ is connected to the control connection 35b₃ of the second pressure converter 35b and thus has an operative connection to the compressed-air brake cylinders 12 of the second bogie 4b of a respective car. Moreover the second switch-over valve means 38b has a pneumatic control connection 38b₄ connected to the emergency line NL.

In a service operating mode of the brake system 6, the second switch-over valve means 38b, because of the zero-pressure (PD=0) emergency line NL, is kept in a first position (as shown in FIG. 4).

In an emergency operating mode of the brake system 6, the second switch-over valve means 38b, because of the pressure PD≠0 activated in the emergency line NL, is kept in a second position.

The second switch-over valve means 38b is embodied such that, in its first position, the second emergency brake flow path NBb is cleared and also the second emergency flow path NFb is blocked and that, in its second position, the second emergency brake flow path NBb is blocked and also the second emergency flow path NFb is cleared.

Moreover a parking brake actuation flow path FBL is formed in the brake control unit 18 by pneumatic line sections for compressed air applied by the parking brake actuation flow means 36, which extends from connection 36₂ of the parking brake actuation flow means 36 to connection 41₂ of the second changeover valve means 41. The parking brake actuation flow path FBL, by means of the second changeover valve means 41, has an operative connection to the parking brake actuation cylinders 14 of the two bogies 4a and 4b of the respective car.

Moreover a emergency actuation flow path NFL is formed by pneumatic line sections for compressed air applied by the emergency control valve means 37, which extends from connection 37₂ of the emergency control valve means 37 to connection 41₂ of the second changeover valve means 41. This emergency actuation flow path NFL, by means of the second changeover valve means 41, likewise has an operative connection to the parking brake actuation cylinders 14 of the two bogies 4a and 4b of the respective car.

Arranged in the course of the parking brake actuation flow path FBL and the emergency actuation flow path NFL is the third switch—over valve means 39, which has pneumatic connections 39₁ 39₂, 39₃. A first of the connections 39₁ is connected to the pneumatic connection 36₂ of the parking brake actuation valve means 36. A second of the connections 39₂ is connected to the connection 41₂ of the second changeover valve means 41 and thus has an operative connection to the compressed-air brake cylinders 12 of the two bogies 4a, 4b of a respective car. Moreover the third switch-over valve means 39 has a pneumatic control connection 39₄ connected to the emergency line NL.

In service operating mode of the brake system 6, the third changeover valve means 39, because of the zero-pressure (PD=0) emergency line NL, is kept in a first position (as shown in FIG. 4).

In emergency operating mode of the brake system 6, the third changeover valve means 39, because of the pressure PD≠0 activated in the emergency line NL, is kept in a second position.

The third changeover valve means 39 is embodied such that, in its first position, the parking brake actuation flow path FBL is cleared and also the emergency actuation flow path NFL is blocked and that, in its second position, the parking brake actuation flow path FBL is blocked and the emergency actuation flow path NFL is cleared.

The following is a description of how the brake system 6 operates.

The directly-acting brake pressure regulators 33a or 33b are each formed from an air inlet valve and an air outlet valve, wherein the air inlet valves and the air outlet valves are electrically activated by the drive and brake control unit 19.

In normal service operating mode the directly-acting brake pressure regulators 33a or 33b, during operational braking and during emergency braking, apply a pilot control pressure Cvla≠0 or Cvlb≠0 to a second of the control connections 35a₄ or 35b₄ of the pressure converters 35a or 35b. In emergency operating mode the two brake pressure regulators 33a or 33b assume the position shown in FIG. 4, so that the control inputs 35a₄ or 35b₄ of the pressure converters 35a or 35b are vented into the open air (Cv1a=0, Cv1b=0).

The directly-acting emergency brake control valve means 34a and 34b, which are only electrically actuated by a safety loop not shown here, are supplied with power in normal service operating mode of the brake system 6 with the safety loop closed, so that the control inputs 35a₄ or 35b₄ of the pressure converters 35a and 35b will be vented into the open air (Cv2a=0, Cv2b=0).

If the safety loop is interrupted for emergency braking, the two emergency brake control valve means 34a and 34b apply pilot pressures Cv2a≠0 or Cv2b≠0 to the first control inputs 35a₃ or 35b₃ of the pressure converters 35a and 35b. The position of the emergency brake control valve means 34a and 34b during emergency braking is shown in FIG. 4.

Present as pilot pressures at the third control inputs 35a₅ or 35b₅ of the pressure converters 35a and 35b are the load pressures Ta or Tb of the air suspension units 7a or 7b, which serve as a measure for a loading state of the rail vehicle 1.

The pressure converters 35a and 35b, as a function of the pilot pressures Cv1a, Cv2a Ta or Cv1b, Cv2b, Tb present at their control inputs, apply the brake pressure Ra or Rb to the compressed-air brake cylinders 12 to the connection 35a₂ or 35b₂. If Ra=0 and Rb=0, then the compressed-air brake actuators 11 are in the released position. If Ra≠0 and Rb≠0 then the compressed-air brake actuators 11 are in a braking position.

In normal service operating mode of the brake system the holding brake (parking brake) is applied by means of the parking brake actuation valve means 36.

In the position of the parking brake actuation valve means 36 shown in FIG. 4, said valve means applies the parking brake actuation pressure L≠0 at its connection 36₂ to the parking brake actuation cylinders 14, so that the parking brake actuators 13 are kept against the force of their springs in the actuation position. In the position in which the parking brake actuation valve means 36 vents the parking brake actuation cylinders 14 into the open air (L=0) the parking brake actuators 13 are kept under the force of their springs in the braking position.

The changeover valve means 40 and 41 prevent the compressed-air brake actuators 11 and the parking brake actuators 13 being in their braking position at the same time.

So that the rail vehicle can rescue itself in an emergency (rescue case), it must be transferred into emergency operating mode. To do this the blocking device 30 in the two drive cars must be moved from its first position shown in FIGS. 2 and 5 into its second position, so that the emergency line NL is blocked at both ends and thus the pressure PD in the emergency line NL can be built up by the emergency pressure module 22. Moreover the activation means 25 must be moved manually from the blocked position shown in FIGS. 2 and 5 into its activation position, so that that this lets the pressure D in the main air reservoir line through as supply pressure to a first connection 54₁ of the pressure converter 54 and also as a pilot pressure to a control connection 54₃ of the pressure converter 54. The pressure converter 52, which is controlled by the speed and brake regulator 59, applies at a further connection 52₂ a further pilot pressure to a further control connection 54₄ of the pressure converter. The pressure converter 54, as a function of the two pilot pressures that are present at its two control connections 54₃ and 54₄, controls the pressure ND in the emergency line NL at a second connection 54₂.

Through the pressure ND applied in the emergency line NL, on the one hand the control connections 38a₃, 38b₃ and 39₃ are activated and thus moved from their first position into their second position, wherein in the second position first emergency brake flow paths NBa and NBb as well as the parking brake actuation flow path FBL are blocked, while the emergency flow paths NFa and NFb as well as the emergency actuation flow path (NFL) are cleared. On the other hand the emergency control valve means 37 are controlled by the pressure ND in the emergency line. The switchover into the second position is made as soon as the pressure ND in the emergency line exceeds 2.5. Then the “low-active” emergency brake control valve means 34a and 34b as well as the parking brake actuation valve means 36 are deactivated by the pneumatic switch-over valve means 38a, 38b and 39.

As soon as the pressure ND in the emergency line reaches 5 bar, all compressed-air brake actuators 11 and all parking brake actuators 13 are moved into the actuation position—i.e. applied.

In the event of an emergency, the rail vehicle can now be smoothly braked, by the pressure ND in the emergency line being reduced to 4.6 to 3.5 bar.

Moreover emergency braking is also possible in the event of an emergency. To do this the emergency line must be vented, which can be done by actuating the electrically-actuatable emergency brake valve means 55 or by a manual activation of the emergency brake button 60.

1-15. (canceled)

16. A brake system, comprising:
a first emergency brake control valve;
a first emergency brake flow path operatively connected to at least one compressed-air brake cylinder for compressed air applied by said first emergency brake control valve means;
an emergency line; and
a switch-over valve having a pneumatic control connection connected to said emergency line, said switch-over valve being configured to assume a first position and a second position;
wherein said emergency line, in a service operating mode of the brake system, is maintained at zero pressure and, in an emergency operating mode of the brake system, said emergency line is subjected to a non-zero pressure, so that said first switch-over valve is kept in the first position in the service operating mode and is kept in the second position in the emergency operating mode;
said first switch-over valve being configured such that, in the first position, said first emergency brake flow path is opened and a first emergency flow path for compressed air applied by an emergency control valve is blocked and that, in the second position, said first emergency brake flow path is blocked and said first emergency flow path is opened.

17. The brake system according to claim 16, further comprising:
a second emergency brake control valve; and
a second switch-over valve having a pneumatic control connection connected to said emergency line such that, in the service operating mode, said second switch-over valve is maintained in a first position and in the emergency operating mode said second switch-over valve is maintained in a second position;
wherein said second switch-over valve is configured such that, in the first position thereof, an emergency brake flow path having an operative connection to at least one second compressed-air brake cylinder is opened for compressed air applied by said second emergency brake control valve and a second emergency flow path is blocked for compressed air applied by said emergency control valve and that, in the second position thereof, said second emergency brake flow path is blocked and said second emergency flow path is opened.

18. The brake system according to claim 17, further comprising:
a parking brake actuation valve; and
a third switch-over valve having a pneumatic control connection connected to said emergency line, such that, during the service operating mode said third switch-over valve is maintained in a first position and during emergency operating mode said third switch-over valve is maintained in a second position;
wherein said third switch-over valve is configured such that, in the first position thereof, a parking brake actuation flow path having an operative connection to at least one parking brake actuation cylinder is opened for compressed air applied by said parking brake actuation valve and an emergency actuation flow path is blocked for compressed air applied by said emergency control valve and that, in the second position thereof, the parking brake actuation flow path is blocked and the third emergency actuation flow path is opened.

19. The brake system according to claim 16, wherein:
said first switch-over valve comprises a plurality of pneumatic connections including a first pneumatic connection connected to a pneumatic connection of said first emergency brake control valve means and a second pneumatic connection with an operative connection to said at least one first compressed-air brake cylinder; and
said emergency control valve has a pneumatic control connection connected to said emergency line, a pneumatic supply connection connected to a brake supply reservoir and a pneumatic connection connected to a third connection of said first switch-over valve.

20. The brake system according to claim 17, wherein:
said second switch-over valve comprises a plurality of pneumatic connections including a first pneumatic connection connected to a pneumatic connection of said second emergency brake control valve, a second pneumatic connection having an operative connection to said at least one second compressed-air brake cylinder and a third pneumatic connection connected to said connection of said emergency control valve.

21. The brake system according to claim 18, wherein:
said third switch-over valve comprises a plurality of pneumatic connections including a first pneumatic connection is connected to a pneumatic connection of said parking brake actuation valve, a second pneumatic connection having an operative connection to said at least one parking brake actuation cylinder and a third connection connected to said connection of said emergency control valve.

22. The brake system according to claim 19, further comprising:
a first pressure converter with a pneumatic supply connection connected to said brake supply reservoir, with a connection connected to said at least one first compressed-air brake cylinder, and with a first pneumatic control connection connected to said second pneumatic control connection of said first switch-over valve.

23. The brake system according to claim 18, further comprising:
a second pressure converter with a pneumatic supply connection connected to said brake supply reservoir, with a connection, connected to said at least one first compressed-air brake cylinder, and with a first pneumatic control connection connected to said second pneumatic control connection of said first switch-over valve.

24. The brake system according to claim 23, further comprising:
a first changeover valve with a first pneumatic input, a second pneumatic input and a pneumatic output;
wherein said first input is connected to said connection of said first pressure converter and said second input is connected to said connection of said first pressure converter.

25. The brake system according to claim 24, further comprising:
a second changeover valve with a first pneumatic input, a second pneumatic input and a pneumatic output;
wherein said first input of said second changeover valve is connected to said output of said first changeover valve means, said second input of said second changeover valve is connected to said second pneumatic connection of said third switch-over valve and said output of said second changeover valve is connected to said at least one parking brake actuation cylinder.

26. The brake system according to claim 16, further comprising an emergency pressure control module for controlling the pressure in said emergency line and an activation valve configured for activating said emergency pressure control module.

27. A rail vehicle, comprising brake system according to claim 16.

28. A method of operating a brake system, the brake system including a first emergency brake control valve device, a first emergency brake flow path operatively connected to at least one compressed-air brake cylinder for compressed air applied by the first emergency brake control valve device, an emergency line and a switch-over valve device having a pneumatic control connection connected to the emergency line, the method comprising:
in a service operating mode of the brake system, maintaining the emergency line at zero pressure and in an emergency operating mode of the brake system applying a non-zero pressure to the emergency line, to thereby keep the first switch-over valve device in a first position in the service operating mode and to keep the first switch-over valve device in a second position in the emergency operating mode;
selectively moving the first switch-over valve device into the first position for opening the first emergency brake flow path and blocking a first emergency flow path for compressed air applied by an emergency control valve device and moving the first switch-over valve device into the second position for blocking the first emergency brake flow path and opening the first emergency flow path.

29. The method according to claim 28, which comprises:
providing the brake system with a second emergency brake control valve device and a second switch-over valve device having a pneumatic control connection connected to the emergency line so that, during service operating mode, the second switch-over valve device is kept in a first position and during emergency operating mode said second switch-over valve device it is kept in a second position;
wherein the second switch-over valve device, in the first position, opens a second emergency brake flow path operatively connected to at least one second compressed-air brake cylinder for compressed air applied by the second emergency brake control valve device and blocks a second emergency flow path for compressed air applied by the control valve device and, in the second position, blocks the second emergency brake flow path and opens the second emergency flow path.

30. The method according to claim 28, which comprises:
providing the brake system with a parking brake actuation valve device and a third switch-over valve device having a control connection connected to the emergency line, so that during service operating mode the third switch-over valve device is kept in a first position and during emergency operating mode in a second position;
wherein the third switch-over valve device, in the first position, opens a parking brake actuation flow path that is operatively connected to a parking brake actuation cylinder for compressed air applied by the parking brake actuation valve device and blocks an emergency actuation flow path for compressed air applied by the emergency control valve device and, in the second position, said third switch-over valve device blocks the parking brake actuation flow path and opens the emergency actuation flow path.
